(19) United States
(12) Patent Application Publication
(10) Pub. No.: US 2012/0328389 A1
(43) Pub. Date: Dec. 27, 2012

(54) FASTENING TOOL

(75) Inventor: Daisuke Asada, Yokohama-shi (JP)

(73) Assignee: NIFCO INC., Yokohama-shi, (JP)

(21) Appl. No.: 13/578,133

(22) PCT Filed: Feb. 7, 2011
(86) PCT No.: PCT/JP2011/052549

§ 371 Date: Aug. 27, 2012

(30) Foreign Application Priority Data
Feb. 10, 2010 (JP) 2011-028218

(51) Int. Cl. F16B 37/04; F16B 39/22

(52) U.S. Cl. 411/108

(57) ABSTRACT

A nut is inserted into a hollow portion inside a structural object (for example, a C-shaped steel) in a state wherein the nut is held in a tilted state which is passable through an opening portion of the structural object (for example, the C-shaped steel). By inserting a male screw portion (for example, a bolt) from an open portion side of a base portion through the opening portion of the structural object (for example, the C-shaped steel), the nut sways in parallel to the opening portion, and a female screw portion faces the opening portion. By a screw-in operation of the male screw portion (for example, the bolt), the male screw portion (for example, the bolt) and the female screw portion screw together, thereby fixing a mating member (for example, a solar cell module).

### FIELD OF TECHNOLOGY

The present invention relates to a fastening tool for fixing a mating member, such as a solar cell module and the like, to a structural object, such as a long C-shaped steel and the like, which is installed in, for example, a roof. After a base portion, holding a nut in a tilted state which is passable through an opening portion of the structural object, is inserted from the opening portion of the structural object, a male screw portion is inserted from the opening portion, so that after the nut is swayed in parallel to the opening portion, the male screw portion can be screwed into a female screw portion of the nut.

### BACKGROUND ART

Conventionally, there is well-known a fastening tool rotatably supporting the nut in the base portion through an axis portion, and inserting the nut in a stand-up state into a penetration hole provided to be pierced in an attachment plate. After that, by a bolt inserted through the penetration hole, the nut can be rotated in a horizontal state (see paragraphs [0009] to [0012], and FIGS. 1, 4, 6, and 7 of Patent Document 1).

In the aforementioned conventional nut, when an end portion of the bolt is pressed, there is provided a guide slope face for acting a force in a rotating direction on the nut (see paragraph [0012] and FIG. 7 of the Patent Document 1).

### PRIOR ART DOCUMENT

### Patent Document

Patent Document 1: Japanese Patent No. 4156404

### SUMMARY OF THE INVENTION

### Problems to be Solved by the Invention

In the aforementioned conventional fastening tool, however, there has been the first problem that there is a possibility that the nut might abruptly rotate from the stand-up state.

Also, in the aforementioned conventional fastening tool, since the nut is inserted into the penetration hole in the stand-up state, there is a need for providing the guide slope face, or supporting the nut through the axis portion, so that a structure becomes complicated, and also there has been a second problem that an existing nut cannot be used.

Thereby, the present invention is made in view of the problems that the aforementioned conventional technology has, and an object of the present invention is to provide a fastening tool, in which after the base portion, holding the nut in the tilted state which is passable through the opening portion of the structural object, is inserted from the opening portion of the structural object, the male screw portion is inserted from the opening portion, so that after the nut is swayed in parallel to the opening portion, the male screw portion can be screwed into the female screw portion of the nut.

### Means for Solving the Problems

The present invention is made in order to achieve the aforementioned object, and the present invention has the following characteristics.

First, the present invention is a fastening tool for fixing a mating member (for example, a solar cell module) to a structural object (for example, a C-shaped steel) whose cross-section is an approximately C shape.

Secondly, the fastening tool comprises a base portion inserted from an opening portion of the structural object (for example, the C-shaped steel), and having a short side shorter than a width of the opening portion; and a nut inserted into the base portion, having a diameter of an outer circumference longer than the width of the opening portion, and including a female screw portion on an inner circumference.

Thirdly, the base portion comprises an open portion allowing the nut and a male screw portion (for example, a bolt) to be inserted.

Fourthly, after the nut is inserted from the open portion of the base portion, in a state wherein the nut is held in a tilted state which is passable through the opening portion of the structural object (for example, the C-shaped steel), the nut is inserted into a hollow portion inside the structural object (for example, the C-shaped steel).

In addition to that, by inserting the male screw portion (for example, the bolt) from an open portion side of the base portion through the opening portion of the structural object (for example, the C-shaped steel), the nut sways in parallel to the opening portion, and the female screw portion faces the opening portion.

Moreover, by a screw-in operation of the male screw portion (for example, the bolt), the male screw portion (for example, the bolt) and the female screw portion screw together, and the nut fixes the mating member (for example, the solar cell module).

The present invention may also comprise the following characteristic.

On an outer circumferential surface of the base portion, there is provided a locking claw locking in an opening edge of the opening portion of the structural object (for example, the C-shaped steel). In that case, by the locking claw, the base portion can be prevented from coming out of the opening portion of the structural object. Also, by elastically abutting the locking claw against the opening edge of the opening portion, the base portion can be prevented from moving into the hollow portion of the structural object, i.e., in a longitudinal direction of the structural object.

The present invention may also comprise the following characteristic.

In the base portion, there is provided an operation knob facing the opening portion in a state wherein the base portion is inserted into the hollow portion of the structural object (for example, the C-shaped steel). In that case, by using the operation knob, the base portion can move into the hollow portion of the structural object, i.e., in the longitudinal direction of the structural object.

The present invention may also comprise the following characteristic.

In the base portion, there is provided a braking portion elastically abutting against the nut when the nut sways. In that case, when the nut sways, the nut is elastically abutted against the braking portion so as to be capable of preventing the nut from deviating from an axis line of the bolt, and preventing the male screw portion and the female screw portion of the nut from coming not to screw together.

The present invention may also comprise the following characteristic.

On an inside surface of the base portion, there is provided a temporary attaching portion temporarily attaching the nut in the tilted state. In that case, by the temporary attaching portion, the nut is temporarily attached in the tilted state so as to be capable of preventing the nut from turning abruptly.

### Effect of the Invention

Since the present invention is structured as mentioned above, after the base portion, holding the nut in the tilted state which is passable through the opening portion of the structural object, is inserted from the opening portion of the structural object, the male screw portion is inserted from the opening portion, so that after the nut is swayed in parallel to the opening portion, the male screw portion can be screwed into the female screw portion of the nut.

### BRIEF DESCRIPTION OF THE DRAWINGS

FIG. 1 is a perspective view of a fastening tool according to the first embodiment of the present invention.

FIG. 2 is an exploded perspective view for explaining an attachment position of the fastening tool, and is a partially perspective view for explaining an attachment state of a support clasp.

FIG. 3 is a partial cross-sectional perspective view for explaining the attachment state of the fastening tool.

FIG. 4 is a perspective view when a bolt is inserted into the fastening tool.

FIG. 5 is a partial cross-sectional perspective view of a base portion for explaining the attachment state of a nut according to the first embodiment of the present invention.

FIG. 6 is a perspective view of the fastening tool in a state wherein the bolt is inserted in the first embodiment of the present invention.

FIG. 7 is a partial cross-sectional perspective view of the base portion in the state wherein the bolt is inserted.

FIG. 8 is a partial cross-sectional view of the base portion for explaining a sway of the nut in the state wherein the bolt is inserted.

FIG. 9 is the other partial cross-sectional view of the base portion for explaining the sway of the nut in the state wherein the bolt is inserted.

FIG. 10 is a perspective view for explaining a screwed state of the bolt and the nut.

FIG. 11 is a partial cross-sectional perspective view of the base portion for explaining a roll-up state of the nut.

FIG. 12 is the other partial cross-sectional perspective view of the base portion for explaining the roll-up state of the nut.

FIG. 13 is a perspective view of the fastening tool for explaining the roll-up state of the nut.

FIG. 14 is a front view of the base portion according to the first embodiment of the present invention.

FIG. 15 is a back view of the base portion.

FIG. 16 is a partial plan view of the base portion.

FIG. 17 is a back view of the base portion.

FIG. 18 is a left side view of the base portion.

FIG. 19 is a right side view of the base portion.

FIG. 20 is a cross-sectional view taken along a line A to A in FIG. 14.

FIG. 21 is a cross-sectional view taken along a line B to B in FIG. 14.

FIG. 22 is a cross-sectional view taken along a line C to C in FIG. 15.

FIG. 23 is a cross-sectional view taken along a line D to D in FIG. 16.

FIG. 24 is a cross-sectional view taken along a line E to E in FIG. 16.

FIG. 25 is a cross-sectional view taken along a line F to F in FIG. 15.

FIG. 26 is a front view of the fastening tool.

FIG. 27 is a right side view of the fastening tool.

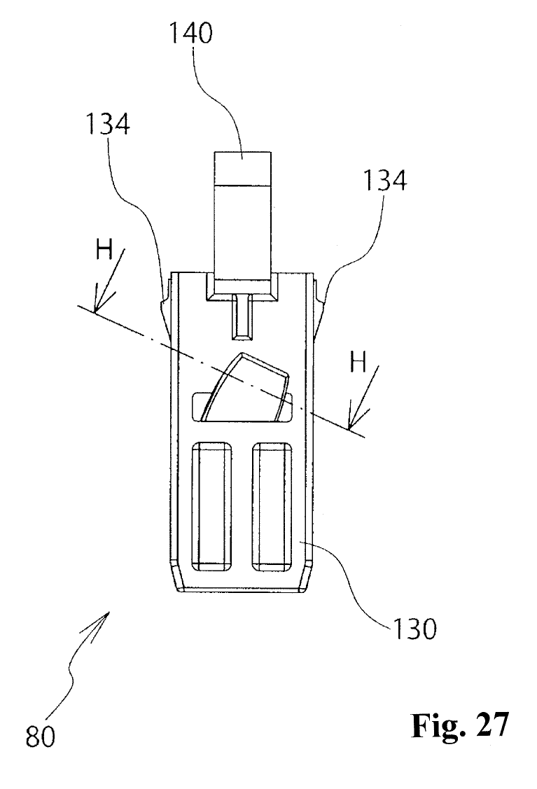

FIG. 28 is a cross-sectional view taken along a line G to G in FIG. 26.

FIG. 29 is a cross-sectional view taken along a line H to H in FIG. 27.

### BEST MODES OF CARRYING OUT THE INVENTION

### Fastening Tool 10

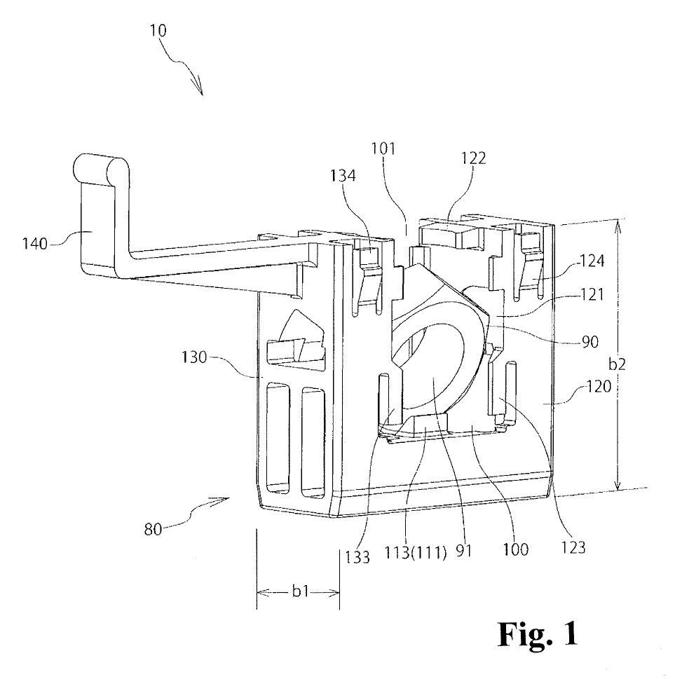

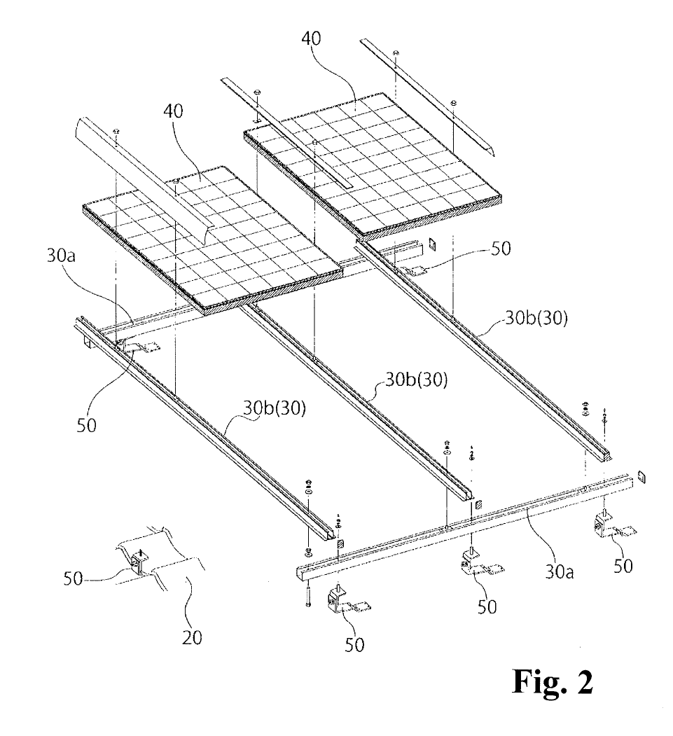

In FIG. 1, the reference numeral 10 represents a fastening tool, and as shown in FIG. 2, the fastening tool 10 is for fixing a mating member such as solar cell module 40 and the like to a structural object such as long C-shaped steel 30 and the like which are installed in, for example, a roof (a tile 20).

Specifically, as shown in FIG. 2, a plurality of support clasps 50 is attached to the tile 20, a plurality of longitudinal crosspieces 30a is crossed and fixed relative to the support clasps 50, and additionally, a plurality of lateral crosspieces 30b which is the C-shaped steels 30 is crossed and fixed relative to the longitudinal crosspieces 30a. At the end, by using the fastening tool 10, a plurality of the solar cell modules 40 is crossed and fixed relative to the lateral crosspieces 30b.

Incidentally, although the longitudinal crosspieces 30a are fixed to the tile 20 through the support clasps 50, they are not limited to the above, and although it is not shown in the drawings, by using, i.e., a support tile in which the support clasps are fixed, the longitudinal crosspieces 30a may be fixed relative to the support tile. Also, although the roof using the tile 20 is illustrated as an example, it is not limited to the above, and although it is not shown in the drawings, a roof without using the tile 20 may be used.

Moreover, although the solar cell modules 40 are fixed by combining the longitudinal crosspieces 30a and the lateral crosspieces 30b, only either one of the longitudinal crosspieces 30a or the lateral crosspieces 30b may be used.

Also, as an attachment position of the solar cell module 40, although the roof (the tile 20) is illustrated as an example, the attachment position is not limited to the above. Also, as the mating member, although the solar cell module 40 is illustrated as an example, the mating member is not limited to the above, and may be a solar energy collector for solar heat, a greening facility, an advertising display, and the like.

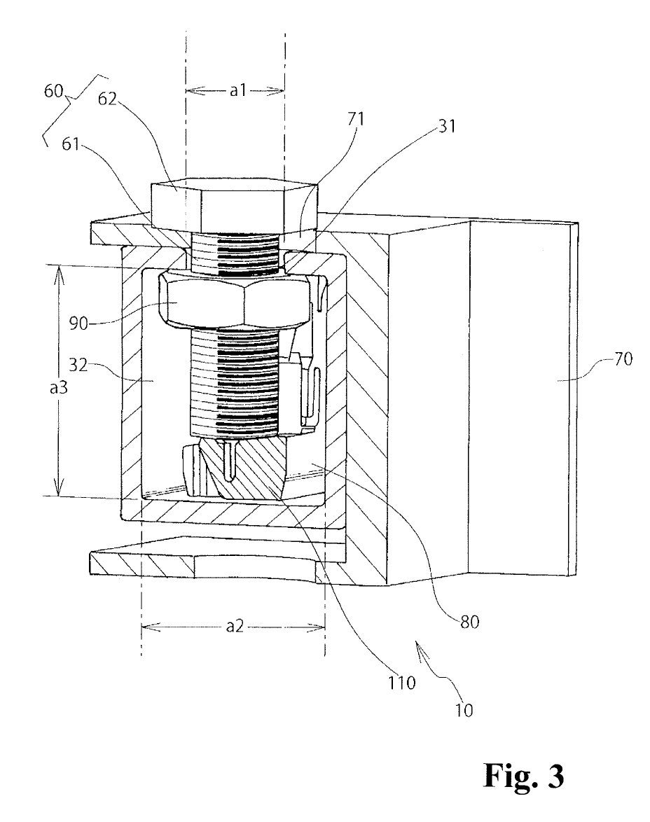

On the other hand, as shown in FIG. 3, the C-shaped steels are formed with a cross-sectional surface of an approximately C shape, and are structured by a long steel material having the cross-sectional surface with a shape in such a way that an alphabet “C” is crushed into a square by slightly folding an opening portion 31 of a groove-shaped steel (a channel) on an inward side. The C-shaped steel 30 includes the opening portion 31 on an upper surface, and includes a hollow portion 32 in an inside. Then, a width a2 of the inside of the hollow portion 32 is wider than a width a1 of the opening portion 31 of the C-shaped steel 30.

As shown in FIG. 3, between the C-shaped steel 30 and the fastening tool 10, there are provided a bolt 60 including a male screw portion screwed into the later-mentioned nut 90 of the fastening tool 10, and a bracket 70 including the later-mentioned through hole 71 wherein an axis portion 61 of the bolt 60 passes through.

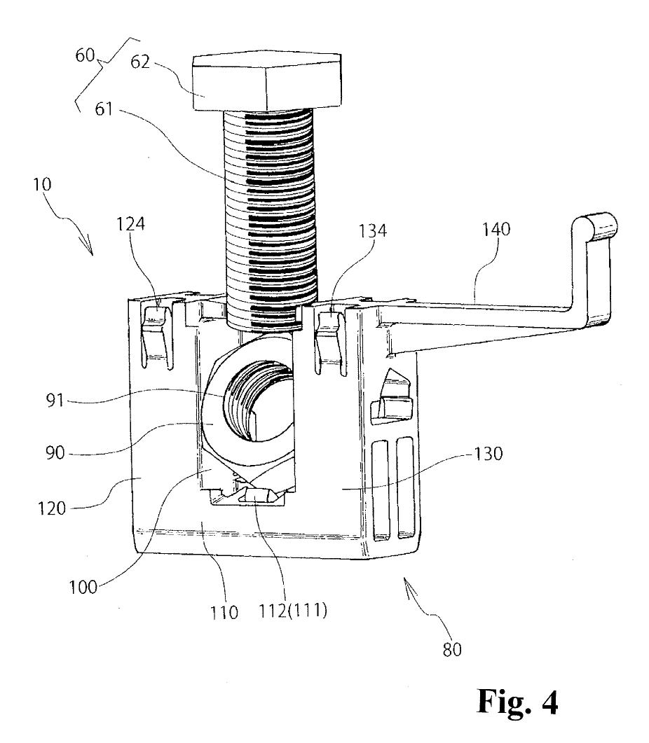

As shown in FIGS. 3 and 4, the bolt 60 is made of metal, includes the male screw portion, and includes the axis portion 61 passing through the later-mentioned through hole 71 of the bracket 70, and a head portion 62 having an outer diameter larger than an inner diameter of the through hole 71.

Incidentally, as the bolt 60, although the metallic bolt is illustrated as an example, the bolt is not limited to the above, and may be made of resin.

As shown in FIG. 3, the bracket 70 is for attaching the solar cell module 40, and is made of metal, and the through hole 71 passes through top and bottom surfaces in a circular form.

Incidentally, as the bracket 70, although the metallic bracket is illustrated as an example, the bracket 70 is not limited to the above, and may be made of resin.

As shown in FIG. 1, the fastening tool 10 broadly comprises the following parts.

Incidentally, the following (1) and (2) will be described later.

(1) Base portion 80

(2) Nut 90

Incidentally the parts of the fastening tool 10 are not limited to the aforementioned (1) and (2).

(Base Portion 80)

As shown in FIGS. 1 and 3, the base portion 80 is inserted from the opening portion 31 of the C-shaped steel 30, and a short side b1 is shorter than the width a1 of the opening portion 31. The base portion 80 is integrally formed by resin having an appropriate amount of elasticity and rigidity.

Also, a height b2 of the base portion 80 is set in a height a3, which is a height of the inside of the hollow portion 32 of the C-shaped steels 30, or less, for example, approximately equal to the height a3.

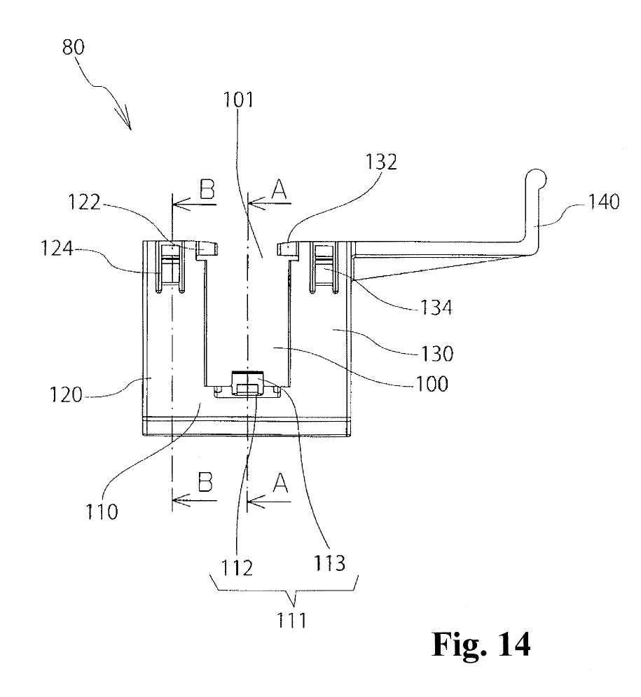

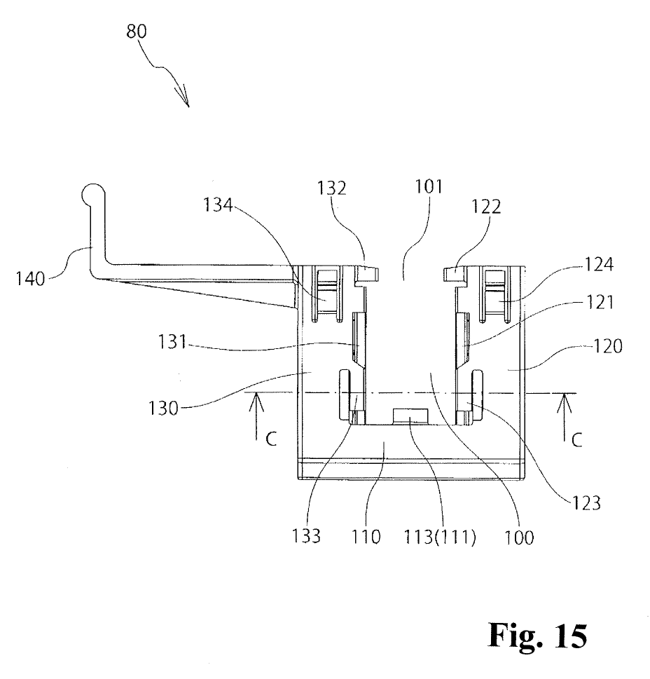

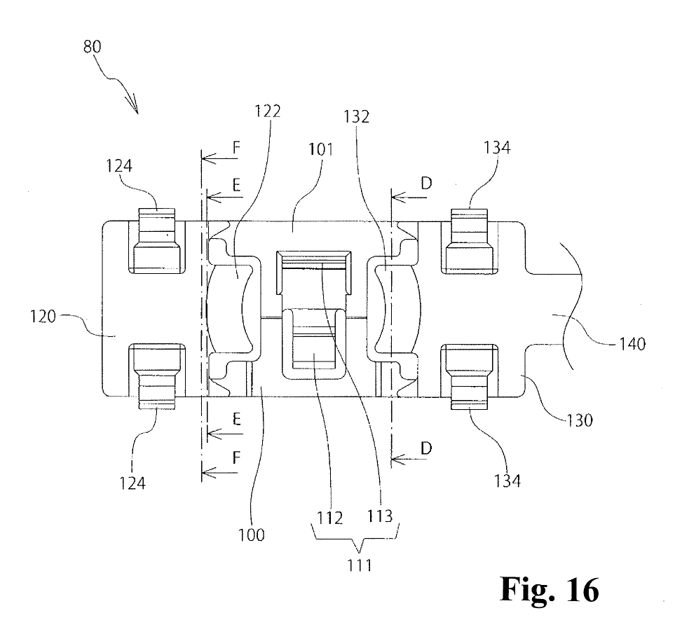

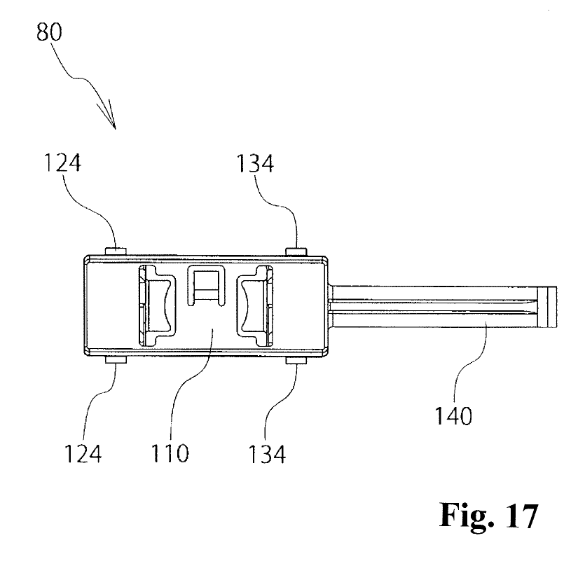

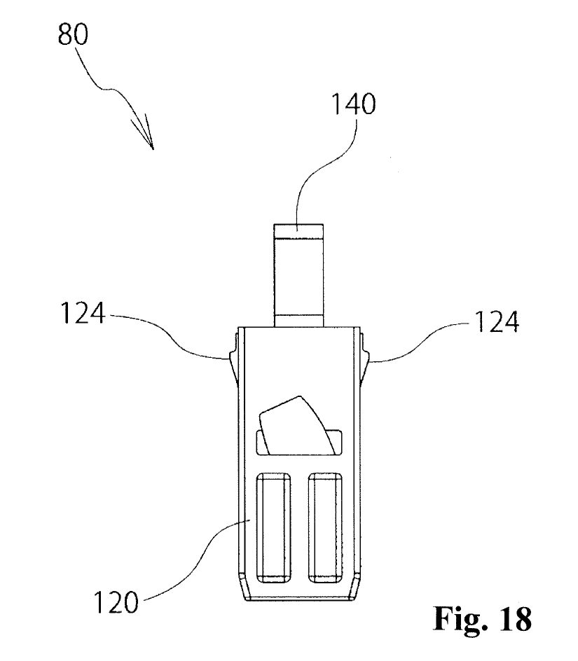

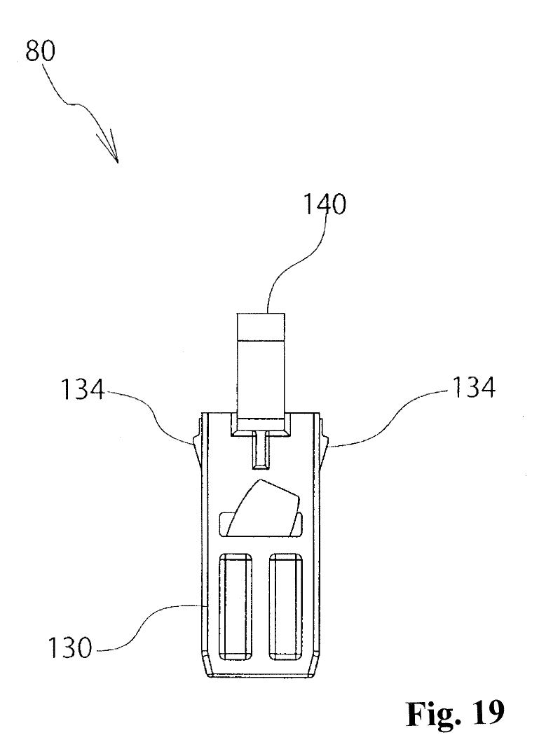

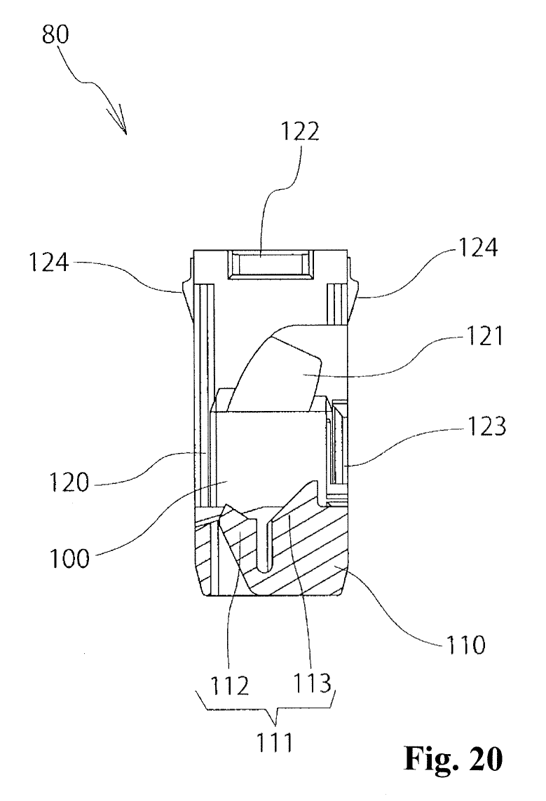

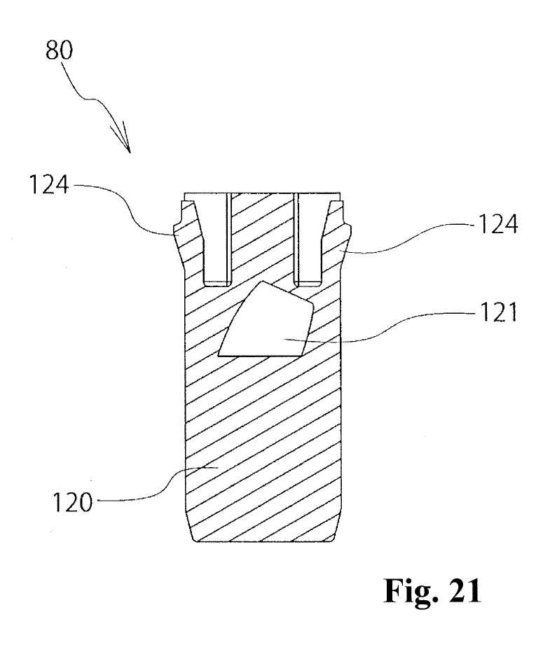

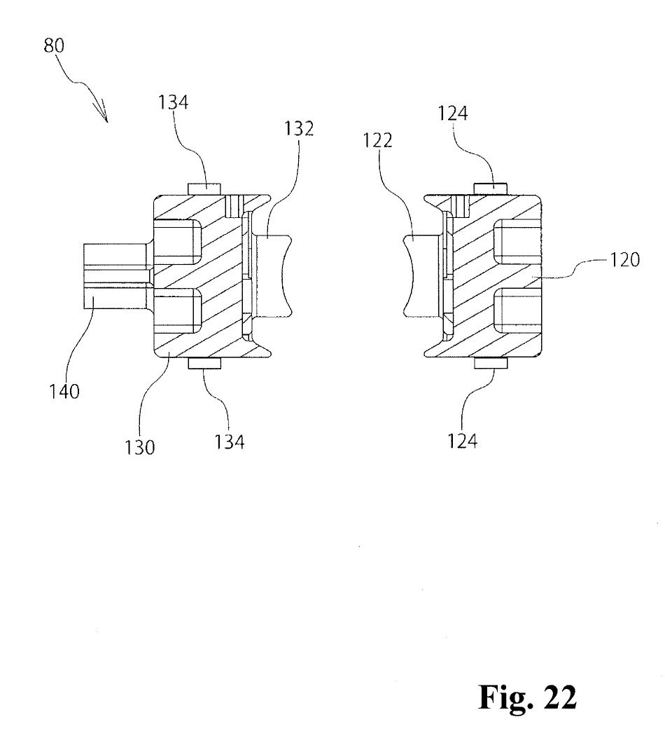

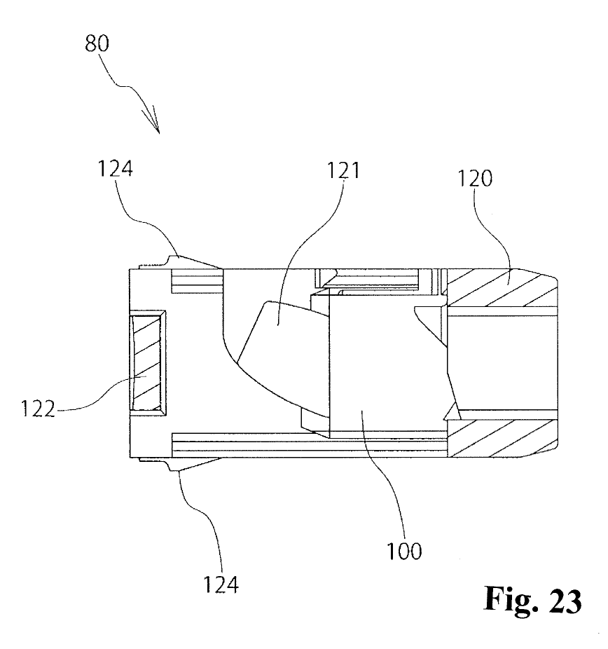

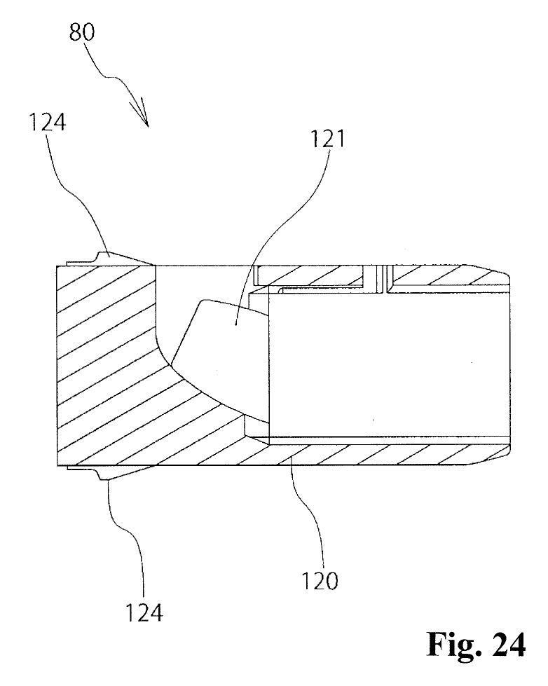

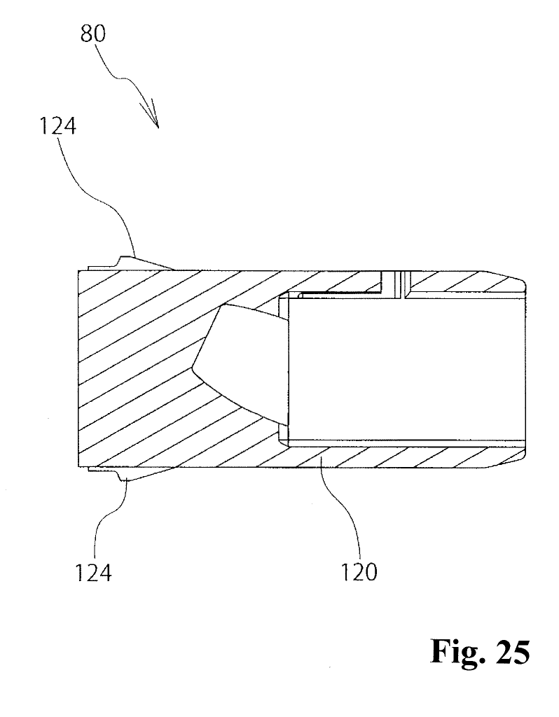

Specifically, as shown in FIGS. 1, and 14 to 25, the base portion 80 broadly comprises each following portion.

Incidentally, the following (1) to (4) will be described later.
(1) Nut holding portion 100
(2) Bottom wall 110
(3) Side walls 120 and 130
(4) Operation knob 140

Incidentally, each portion of the base portion 80 is not limited to the aforementioned (1) to (4).

(Nut 90)

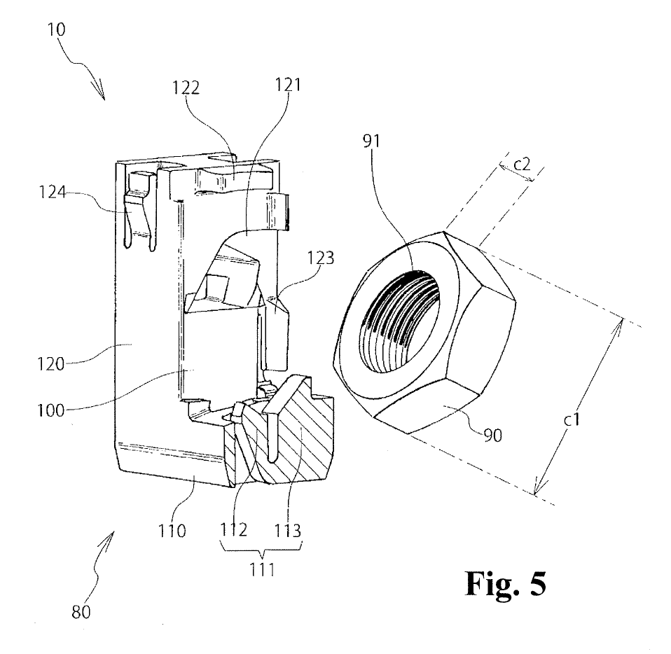

As shown in FIGS. 3 and 5, the nut 90 is inserted into the base portion 80, a diameter c1 of an outer circumference is longer than the width a1 of the opening portion 31, and the nut 90 includes a female screw portion 91 on an inner circumference. For the nut 90, a commercially-available metallic hexagon nut is used.

Incidentally, as for the nut 90, although the metallic nut is illustrated as an example, the nut is not limited to the above, and may be made of resin.

As shown in FIGS. 1 and 3, after the nut 90 is inserted from an open portion 101 of the base portion 80, in a state wherein the nut 90 is held in a tilted state passable through the opening portion 31 of the C-shaped steels 30, the nut 90 is inserted into the hollow portion 32 of the C-shaped steel 30.

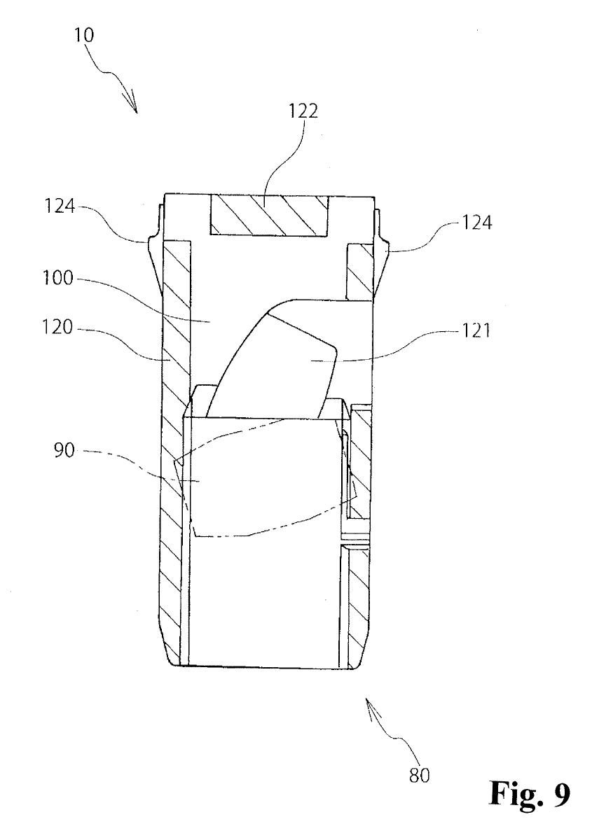

In addition to that, as shown in FIGS. 3, 4, 6, and 7 to 9, by inserting the bolt 60 from an open portion 101 side of the base portion 80 through the opening portion 31 of the C-shaped steel 30, the nut 90 sways in parallel to the opening portion 31, and the female screw portion 91 faces the opening portion 31.

Moreover, as shown in FIGS. 3, 10, and 13, by a screw-in operation of the bolt 60, the bolt 60 and the female screw portion 91 screw together, and through the bracket 70, the nut 90 fixes the solar cell modules 40.

(Nut Holding Portion 100)

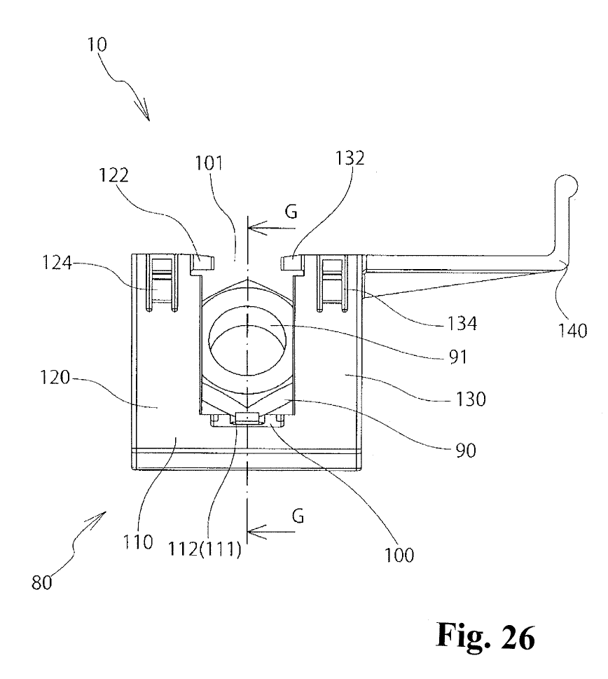

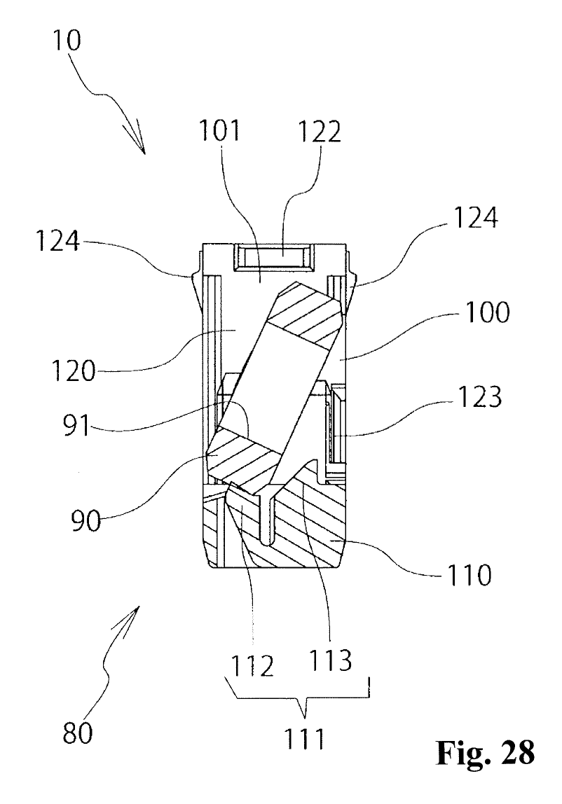

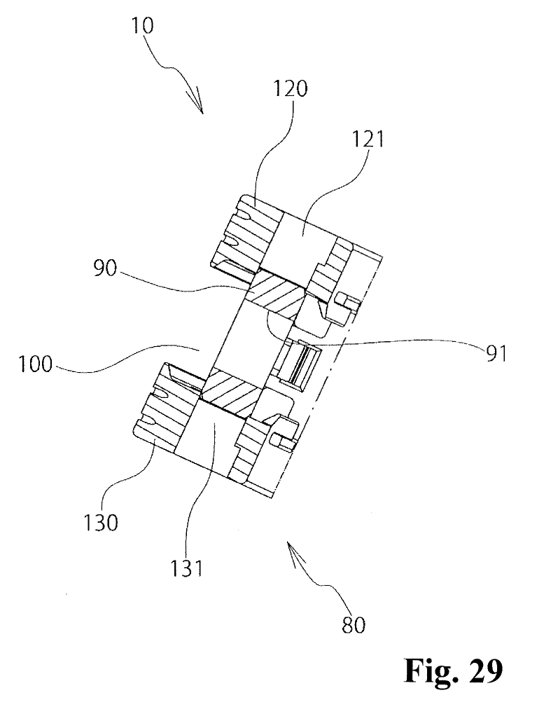

As shown in FIGS. 1, 26, 28, and 29, the nut holding portion 100 is for holding the nut 90 which has been inserted from the open portion 101.

Specifically, as shown in FIGS. 1, 14, and 15, the nut holding portion 100 is formed in a concave shape, and is formed in an inside whose three sides are surrounded by the later-mentioned bottom wall 110, and a pair of the side walls 120 and 130 opposed in a longitudinal direction of the C-shaped steels 30. In the open portion 101, an upper surface and both side surfaces in a direction of the short side b1 of the base portion 80 are open.

(Bottom Wall 110)

As shown in FIGS. 1, 14, and 15, the bottom wall 110 is positioned in a bottom of the nut holding portion 100.

As shown in FIGS. 5, 7, 8, 20, and 28, on an upper surface of the bottom wall 110, there is provided a convex support portion 111 which supports in a state wherein a lower side of the outer circumference of the nut 90 is tilted.

The support portion 111 comprises two small and large pieces of a small protrusion 112 and a large protrusion 113 protruding in a mountain shape apart in the direction of the short side b1 of the base portion 80. The small protrusion 112, protruding in a small mountain shape, is for supporting by a tilted surface thereof in a state wherein an angle portion of the nut 90 is tilted. The large protrusion 113 protruding in a large mountain shape functions as a guide when the nut 90 is inserted. Namely, the nut 90 is held in the tilted state only by the small protrusion 112.

(Side Walls 120 and 130)

As shown in FIGS. 1, 14, and 15, the side walls 120 and 130 extend upward from a front and back in the longitudinal direction of the C-shaped steel 30 of the bottom wall 110, and are opposed by sandwiching the nut holding portion 100.

Specifically, as shown in FIGS. 1, and 14 to 25, in the side walls 120 and 130, there comprises each following portion.

Incidentally, the following (1) to (4) will be described later.
(1) Temporary attaching portions 121 and 131
(2) Guide portions 122 and 132
(3) Braking portions 123 and 133
(4) Locking claws 124 and 134

Incidentally, each portion of the side walls 120 and 130 is not limited to the aforementioned (1) to (4).

(Operation Knob 140)

Although it is not shown in the drawings, the operation knob 140 faces the opening portion 31 in a state wherein the base portion 80 is inserted into the hollow portion 32 of the C-shaped steel 30 as shown in FIGS. 1, 14, and 15.

Specifically, the operation knob 140 extends in the longitudinal direction of the C-shaped steels 30 from one of the side walls 120 and 130, and is bent upward in an L shape. Although it is not shown in the drawings, the operation knob 140 protrudes upward from the opening portion 31 in the state wherein the base portion 80 is inserted into the hollow portion 32 of the C-shaped steels 30.

Incidentally, although the operation knob 140 is provided in one of the side walls 120 and 130, it is not limited to the above, and the operation knob 140 may be provided in the other portion of the base portion 80. Also, although one piece of the operation knob 140 is provided, it is not limited to the above, and a plurality of the operation knobs may be provided. Moreover, although the operation knob 140 protrudes upward from the opening portion 31, it is not limited to the above, and the operation knob 140 may face the opening portion 31, or may be receded from the opening portion 31. In that case, by inserting one's fingers, a jig, and the like from the opening portion 31, the operation knob 140 may be slid.

(Temporary Attaching Portions 121 and 131)

As shown in FIGS. 1, 5, 20, 21, and 29, the temporary attaching portions 121 and 131 are formed in a concave shape on opposing inside surfaces of the side walls 120 and 130, and are for temporarily attaching the nut 90 in the tilted state.

The temporary attaching portions 121 and 131 have a groove shape tilted in conformity to a tilt of the nut 90, and one portion of the outer circumference of the nut 90 is fitted in.

Incidentally, although a pair of the temporary attaching portions 121 and 131 is provided, it is not limited to the above, and the temporary attaching portions 121 and 131 may be provided with one piece, or three pieces or more.

(Guide Portions 122 and 132)

As shown in FIGS. 1, 4, and 16, the guide portions 122 and 132 are positioned on an open upper surface of the open portion 101, and are for controlling an insertion direction of the axis portion 61 of the bolt 60. A pair of the opposing guide portions 122 and 132 protrudes from the opposing inside surfaces of the side walls 120 and 130.

A thickness of the guide portions 122 and 132, i.e., a thickness of the insertion direction of the bolt 60 is set to be thinner than a thickness of the C-shaped steels 30.

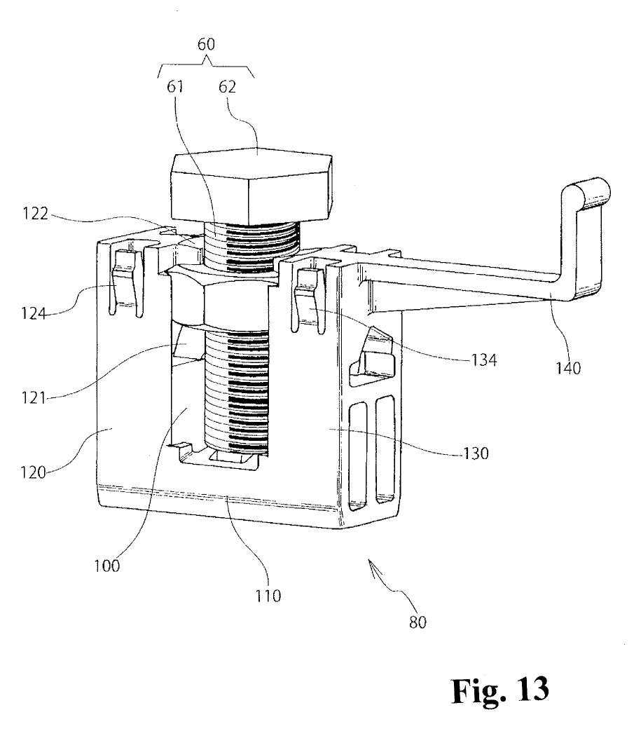

Namely, as shown in FIG. 3, since the thickness of the C-shaped steels 30 is thick, when the nut 90 is rolled up, an inner surface of an end portion of the C-shaped steel 30 which have been bent in the L shape of the cross-sectional surface by being opposed toward the opening portion 31, i.e., in FIG. 3, a lower surface abuts against an upper surface of the nut 90. In a state wherein the upper surface of the nut 90 abuts against the lower surface of the end portion of the C-shaped steel 30, since the thickness of the guide portions 122 and 132 is thin, the upper surface of the nut 90 is positioned to be separated from the lower surface of the guide portions 122 and 132 in FIG. 13. Incidentally, when FIG. 3 and FIG. 13 are compared, a direction of the base portion 80 differs 90 degrees.

Also, although a pair of the guide portions 122 and 132 is provided, it is not limited to the above, and the guide portions 122 and 132 may be provided with one piece, or three pieces or more.

(Braking Portions 123 and 133)

As shown in FIGS. 1, 7, and 8, the braking portions 123 and 133 elastically abut when the nut 90 sways.

Specifically, a pair of the braking portions 123 and 133 is formed, and upper end portions are respectively connected to the side walls 120 and 130, and the braking portions 123 and 133 extend downward in a rod shape.

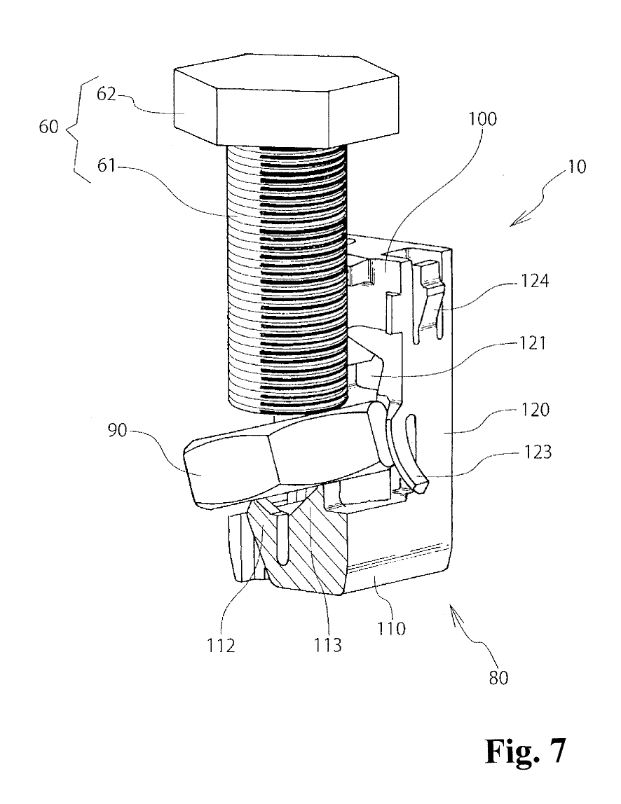

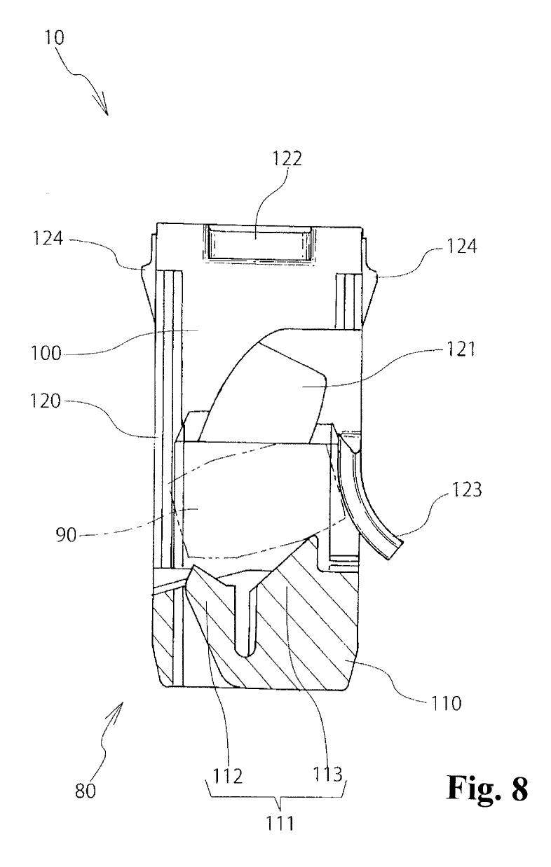

The braking portions 123 and 133 are pressed by the outer circumference of the nut 90 when the nut 90 sways in such a way as to fall over in parallel to the opening portion 31 from the tilted state, and as shown in FIGS. 7 and 8, at a center of the upper end portions respectively connected to the side walls 120 and 130, the braking portions 123 and 133 bend toward an outward of the short side b1 of the base portion 80. Consequently, the nut 90 sways in such a way as to slowly and smoothly fall over. Also, since there includes a pair of the braking portions 123 and 133, when the nut 90 sways, the nut 90 falls over in parallel without twisting.

Incidentally, although a pair of the braking portions 123 and 133 is provided, it is not limited to the above, and the braking portions 123 and 133 may be provided with one piece, or three pieces or more.

(Locking Claws 124 and 134)

As shown in FIGS. 1, and 14 to 19, the locking claws 124 and 134 are formed on an outer circumferential surface of the base portion 80, and lock in an opening edge of the opening portion 31 of the C-shaped steels 30.

Specifically, the locking claws 124 and 134 respectively protrude outward from right-and-left outside surfaces in a direction of the short side b1 of the side walls 120 and 130, are disposed in four directions, and are provided with four pieces in total. When the locking claws 124 and 134 pass through the opening portion 31, the locking claws 124 and 134 are bent inward by being pressed by an inner edge thereof so as to pass through the opening portion 31, and after passing through the opening portion 31, the locking claws 124 and 134 elastically restore to original state so as to prevent the base portion 80 from coming out of the opening portion 31.

On the other hand, the height b2 of the base portion 80 is set to be approximately equal to the height a3 of the inside of the hollow portion 32 of the C-shaped steels 30, so that when the base portion 80 is fitted into the hollow portion 32, as shown in FIG. 3, a bottom thereof is placed on a bottom of the hollow portion 32. Consequently, when the locking claws 124 and 134 have restored to an original state after passing through the opening portion 31, the locking claws 124 and 134 elastically abut against inner surfaces on both sides of the opening portion 31 so as to prevent the base portion 80 from moving in the longitudinal direction of the C-shaped steel 30.

Incidentally, although four pieces of the locking claws 124 and 134 are provided, they are not limited to the above, and the locking claws 124 and 134 may be provided with one piece, two pieces, three pieces, or five pieces or more.

(Attachment Method of Fastening Tool 10)

Next, as shown in FIG. 3, by using the fastening tool 10 having the aforementioned structure, an attachment method fixing the bracket 70 for attaching the solar cell module 40, which is the mating member, relative to the C-shaped steel 30, which is the structural object, using the bolt 60, will be explained.

(Assembly of Fastening Tool 10)

First, as shown in FIGS. 1, 26, 28, and 29, the fastening tool 10 is assembled by obliquely inserting the nut 90 from the open portion 101 of the base portion 80.

When the nut 90 is obliquely inserted, the lower side of the outer circumference thereof is supported by the convex support portion 111, both sides of the outer circumference are fitted into the concave temporary attaching portions 121 and 131, and the nut 90 is held in the nut holding portion 100 in the tilted state.

(Temporary Attachment of Fastening Tool 10 to C-Shaped Steel 30)

Next, as shown in FIG. 3, the assembled fastening tool 10 is inserted in conformity to the opening portion 31 of the C-shaped steel 30, so that the fastening tool 10 is temporarily attached relative to the C-shaped steel 30.

Namely, with a direction wherein the width a1 of the opening portion 31 and the short side b1 of the base portion 80 of the fastening tool 10 correspond, the base portion 80 is inserted from an upper side in conformity to the opening portion 31. When the base portion 80 is inserted, the locking claws 124 and 134 protruding outward in the direction of the short side b1 thereof abut against the inner edge of the opening portion 31.

Here, when the base portion 80 is strongly inserted, the base portion 80 is pressed by the inner edge of the opening portion 31, and the locking claws 124 and 134 are bent inward, so that the locking claws 124 and 134 pass through the opening portion 31, and after passing through the opening portion 31, the locking claws 124 and 134 elastically restore to the original state so as to prevent the base portion 80 from coming out of the opening portion 31.

Also, at that time, when the base portion 80 is fitted into the hollow portion 32, the bottom thereof is placed on the bottom of the hollow portion 32, and the locking claws 124 and 134 elastically abut against the inner surfaces on both sides of the opening portion 31 so as to prevent the base portion 80 from moving in the longitudinal direction of the C-shaped steels 30.

Moreover, although it is not shown in the drawings, the operation knob 140 of the base portion 80 protrudes upward from the opening portion 31. Consequently, by pinching the operation knob 140 and sliding the base portion 80 along the longitudinal direction of the C-shaped steels 30, the after-mentioned attachment positioning of the bracket 70 can be carried out.

(Attachment of Bracket 70 to C-Shaped Steel 30)

Next, by using the fastening tool 10 attached to the C-shaped steel 30, as shown in FIG. 3, the bracket 70 is attached relative to the C-shaped steel 30.

First, the axis portion 61 of the bolt 60 is passed through the through hole 71 of the bracket 70, and the axis portion 61 which has protruded from the through hole 71 is inserted into the open portion 101 of the fastening tool 10 by passing through the opening portion 31 of the C-shaped steel 30.

As shown in FIG. 4, when the axis portion 61 of the bolt 60 is inserted, an end portion thereof abuts against a tilted upper side surface of the nut 90.

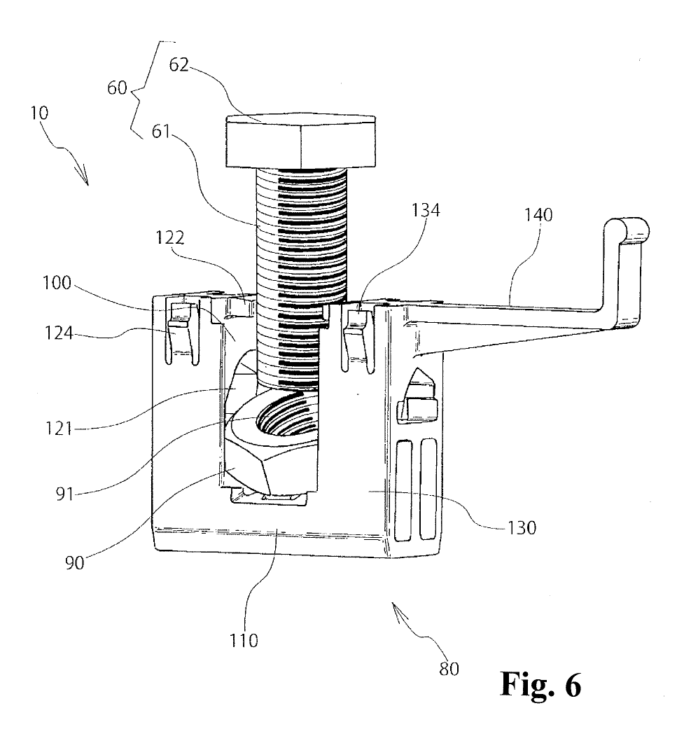

Here, when the axis portion 61 is strongly inserted, as shown in FIGS. 6 to 9, the nut 90 is pressed by the end portion thereof so as to fall against the bottom wall 110 of the nut holding portion 100.

At that time, as shown in FIGS. 7 and 8, by being pressed by the outer circumference of the nut 90, the braking portions 123 and 133 bend, so that the nut 90 sways in such a way as to slowly and smoothly fall over.

When the nut 90 falls over, the female screw portion 91 faces the opening portion 31, and an axis center of the axis portion 61 of the bolt 60 and a center of the female screw portion 91 correspond.

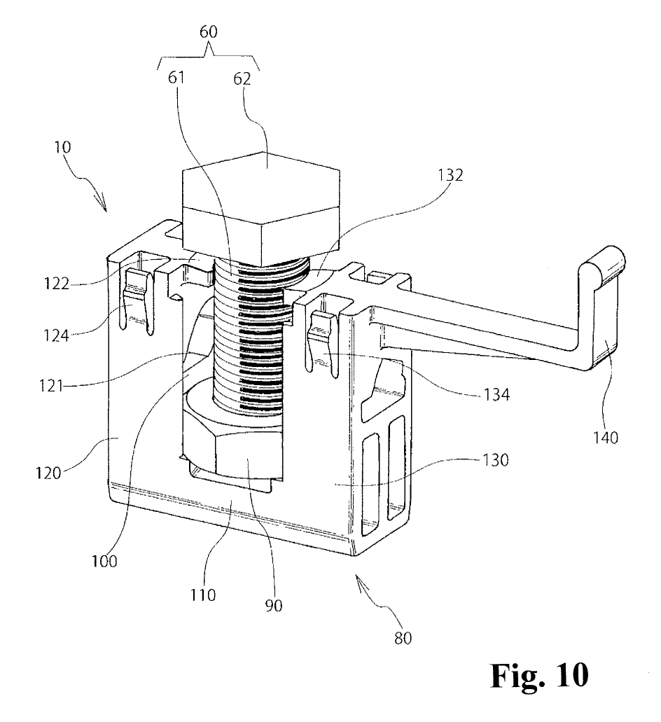

Consequently, as shown in FIGS. 10 and 13, when the bolt is screwed in, in the axis portion 61, the male screw portion (for example, the bolt 60) and the female screw portion (91) screw together.

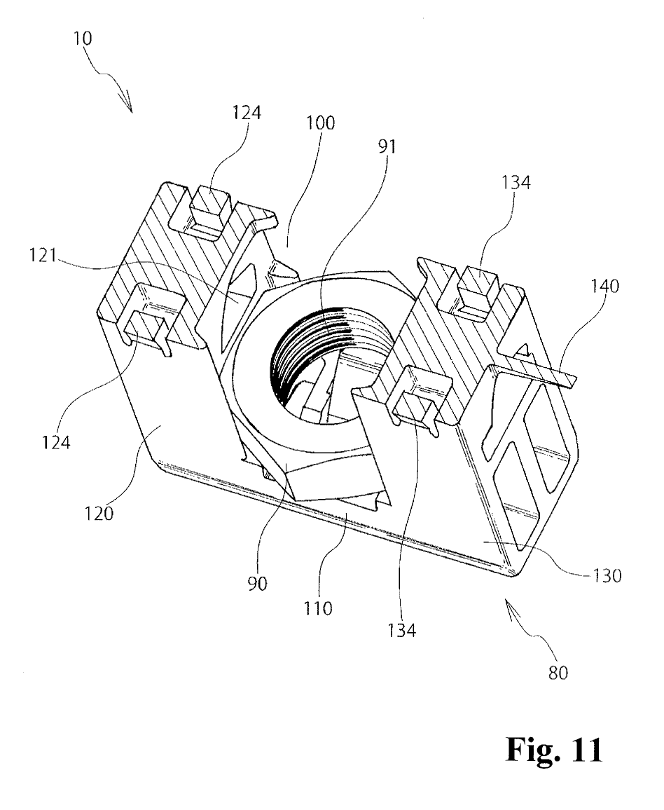

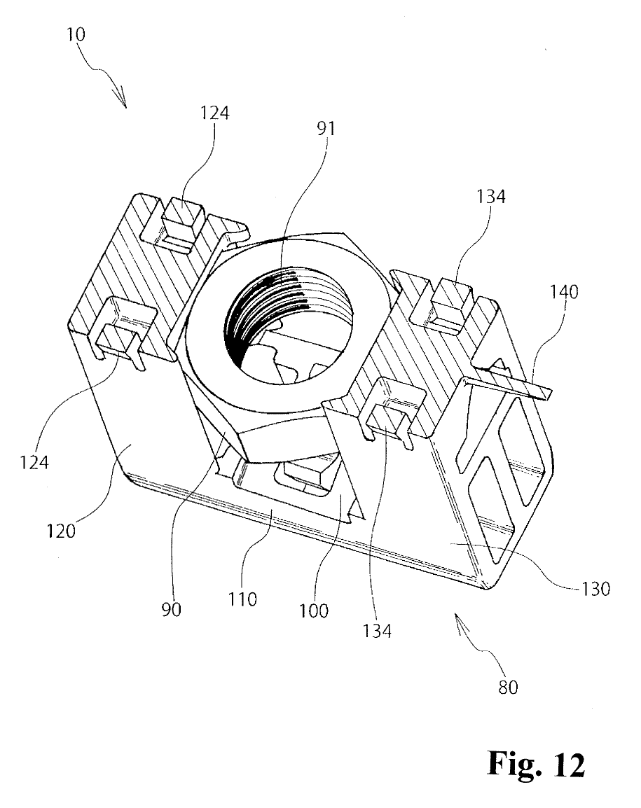

As shown in FIGS. 3, and 10 to 13, when the bolt 60 is screwed in further, the nut 90 moves upward inside the hollow portion 32, and abuts against an inner surface which is positioned in an outer edge of the opening portion 31. Accordingly, four pieces of metallic components of the nut 90, the C-shaped steels 30, the bracket 70, and the head portion 62 of the bolt 60 are mutually attached, so that the bracket 70 is fixed relative to the C-shaped steels 30.

Incidentally, all contents of the specification, claims, drawings, and abstract of Japanese Patent Application No. 2010-028218 filed on Feb. 10, 2010 are cited in their entireties herein and are incorporated as a disclosure of the specification of the present invention.

1. A fastening tool for fixing a mating member to a structural object whose cross-sectional surface is an approximately C shape, comprising:
a base portion inserted from an opening portion of the structural object, and having a short side shorter than a width of the opening portion; and
a nut inserted into the base portion, having a diameter of an outer circumference longer than the width of the opening portion, and including a female screw portion on an inner circumference,
wherein the base portion includes an open portion allowing the nut and a male screw portion to be inserted,
wherein after the nut is inserted from the open portion of the base portion, the nut is inserted into a hollow portion inside the structural object, in a state wherein the nut is held in a tilted state passable through the opening portion of the structural object, and
the male screw portion is inserted from an open portion side of the base portion through the opening portion of the structural object, so that the nut sways in parallel to the opening portion, and the female screw portion faces the opening portion, and
the male screw portion and the female screw portion screw together by a screw-in operation of the male screw portion, to fix the mating member.

2. A fastening tool according to claim 1, wherein an outer circumferential surface of the base portion includes a locking claw locking with an opening edge of the opening portion of the structural object.

3. A fastening tool according to claim 1, wherein the base portion includes an operation knob facing the opening portion in a state wherein the base portion is inserted into the hollow portion of the structural object.

4. A fastening tool according to claim 1, wherein the base portion includes a braking portion elastically abutting against the nut when the nut sways.

5. A fastening tool according to claim 1, wherein an inside surface of the base portion includes a temporary attaching portion temporarily attaching the nut in the tilted state.
